(19) United States
(12) Patent Application Publication
(10) Pub. No.: US 2013/0153142 A1
(43) Pub. Date: Jun. 20, 2013

(54) REINFORCING SHEET AND REINFORCING METHOD

(71) Applicant: Yasuhiko Kawaguchi, Osaka (JP)

(72) Inventor: Yasuhiko Kawaguchi, Osaka (JP)

(73) Assignee: NITTO DENKO CORPORATION, Osaka (JP)

(21) Appl. No.: 13/820,682

(22) PCT Filed: Aug. 22, 2011
(86) PCT No.: PCT/JP2011/068865

§ 371 Date: Mar. 4, 2013

(30) Foreign Application Priority Data
Sep. 6, 2010 (JP) 2010-199033

(51) Int. Cl. C09D 5/08

(52) U.S. Cl. CPC C09D 5/08
USPC 156/276; 442/111; 252/503

(57) ABSTRACT

A reinforcing sheet to be bonded to a metal adherend includes a resin layer and a constraining layer laminated on the resin layer. The resin layer contains a thermosetting resin, a metal which has a higher ionization tendency than that of the metal adherend, and an electrically-conductive carbon.

### TECHNICAL FIELD

The present invention relates to a reinforcing sheet and a reinforcing method, to be specific, to a reinforcing sheet used by being bonded to a steel plate or the like of various industrial products and a reinforcing method in which the steel plate or the like is reinforced using the reinforcing sheet.

### BACKGROUND ART

Conventionally, an automobile steel plate is generally processed into a thin plate of 0.6 to 0.8 mm so as to reduce the weight of a vehicle body. Therefore, it has been known that a steel plate reinforcing sheet including a constraining layer and a resin layer is bonded to the inner side of the steel plate and reinforcement of the steel plate is achieved by curing of the resin layer.

As such a steel plate reinforcing sheet, for example, a steel plate reinforcing sheet in which a resin layer containing a rubber, an epoxy resin, and an electrically-conductive filler is laminated on a constraining layer such as a glass cloth has been proposed (ref: for example, Patent Document 1).

In such a steel plate, the steel plate is subjected to an electrodeposition coating after the steel plate reinforcing sheet is bonded thereto and the resin layer is cured by heating at the time of drying the coating. In this manner, the steel plate is reinforced.

### Prior Art Document

### Patent Document

Patent Document 1: Japanese Unexamined Patent Publication No. 2006-281741

### SUMMARY OF THE INVENTION

### Problems to be solved by the Invention

However, in the steel plate reinforcing sheet, a portion of the steel plate to which the steel plate reinforcing sheet is bonded is not subjected to a coating, so that there is a disadvantage that when water or oxygen infiltrates a bonded portion of the steel plate reinforcing sheet in the steel plate, the steel plate is oxidized and corrosion such as rust occurs.

It is an object of the present invention to provide a reinforcing sheet which is capable of reducing the oxidation of a bonded portion of the reinforcing sheet in a metal adherend over a long period of time and a reinforcing method using the reinforcing sheet.

### Solution to the Problems

In order to achieve the above-described object, a reinforcing sheet to be bonded to a metal adherend of the present invention includes a resin layer and a constraining layer laminated on the resin layer, wherein the resin layer contains a thermosetting resin, a metal which has a higher ionization tendency than that of the metal adherend, and an electrically-conductive carbon.

In the reinforcing sheet of the present invention, it is preferable that the volume resistivity of the resin layer is 1×10⁸ Ω cm or less.

In the reinforcing sheet of the present invention, it is preferable that the metal is zinc.

In the reinforcing sheet of the present invention, it is preferable that the resin layer further contains a curing agent and the thermosetting resin further contains an epoxy resin.

In the reinforcing sheet of the present invention, it is preferable that the resin layer further contains a cross-linking agent and the thermosetting resin further contains a rubber.

In the reinforcing sheet of the present invention, it is preferable that the constraining layer is made of a glass cloth.

A reinforcing method of the present invention includes bonding the above-described reinforcing sheet to a metal adherend to heat a resin layer.

A reinforcing method of the present invention includes bonding the above-described reinforcing sheet in which a metal is zinc to a steel plate or a zinc-plated steel plate to heat a resin layer.

### Effect of the Invention

When the reinforcing sheet of the present invention is bonded to the metal adherend to be then heated, the metal adherend can be reinforced by curing of the thermosetting resin.

In the reinforcing sheet of the present invention, the metal which has a higher ionization tendency than that of the metal adherend and the electrically-conductive carbon are contained in the resin layer. Therefore, in the bonded portion of the reinforcing sheet in the metal adherend, the metal adherend is not easily oxidized while the metal contained in the resin layer is oxidized due to the function of a local cell. Accordingly, the metal adherend can be reinforced, and the oxidation of the metal adherend is reduced, so that the occurrence of corrosion such as rust can be reduced.

### BRIEF DESCRIPTION OF THE DRAWINGS

FIG. 1 shows process drawings for illustrating one embodiment of a method for reinforcing a steel plate as a metal adherend using a reinforcing sheet of the present invention:

(a) illustrating a step of preparing the reinforcing sheet and peeling off a releasing paper,

(b) illustrating a step of bonding the reinforcing sheet to the steel plate, and

(c) illustrating a step of heating the reinforcing sheet to be cured.

### EMBODIMENT OF THE INVENTION

A reinforcing sheet of the present invention is to be bonded to a metal adherend and includes a resin layer and a constraining layer laminated on the resin layer.

In the present invention, the resin layer, which allows close contact and integration with the constraining layer by curing and reinforces the metal adherend, is formed from a curable composition which can be cured by heating into a sheet shape.

The curable composition contains at least a thermosetting resin, a metal which has a higher ionization tendency than that of the metal adherend, and an electrically-conductive carbon.

The thermosetting resin is not particularly limited and examples thereof include an epoxy resin, a rubber, or a mixture of the epoxy resin and the rubber.

The epoxy resin is not particularly limited and examples thereof include an aromatic epoxy resin such as a bisphenol epoxy resin (for example, a bisphenol A epoxy resin, a bisphenol F epoxy resin, a bisphenol S epoxy resin, a hydrogenated bisphenol A epoxy resin, a dimer acid-modified bisphenol A epoxy resin, and the like), a novolak epoxy resin (for example, a phenol novolak epoxy resin, a cresol novolak epoxy resin, and the like), a naphthalene epoxy resin, and a biphenyl epoxy resin; a dimer acid epoxy resin; a nitrogen-containing-cyclic epoxy resin such as triepoxypropyl isocyanurate (triglycidyl isocyanurate) and a hydantoin epoxy resin; an aliphatic epoxy resin; an alicyclic epoxy resin (for example, a dicyclo ring-type epoxy resin and the like); a glycidylether epoxy resin, a glycidylester epoxy resin, and a glycidylamine epoxy resin.

These epoxy resins can be used alone or in combination.

Of the epoxy resins, in view of reinforcing characteristics, preferably, a bisphenol epoxy resin such as a bisphenol A epoxy resin is used.

The epoxy equivalent of the epoxy resin is, for example, 90 to 1000 g/eq, or preferably 100 to 800 g/eq.

The mixing ratio of the epoxy resin with respect to 100 parts by mass of the curable composition is, for example, 5 to 60 parts by mass, or preferably 10 to 30 parts by mass.

Examples of the rubber include an acrylonitrile-butadiene rubber, a styrene synthetic rubber, an isoprene rubber, a butadiene rubber, and a natural rubber.

These rubbers can be used alone or in combination.

Of the rubbers, preferably, an acrylonitrile-butadiene rubber and a styrene synthetic rubber are used.

The acrylonitrile-butadiene rubber is a synthetic rubber obtained by copolymerization of acrylonitrile and butadiene. The acrylonitrile-butadiene rubber also contains, for example, a terpolymer in which a carboxyl group or the like is introduced.

In the acrylonitrile-butadiene rubber, the content of the acrylonitrile is, for example, 15 to 50 mass %, or preferably 25 to 40 mass % and the Mooney viscosity (ML 1+4, at 100° C.) is, for example, 25 to 90, or preferably 30 to 85.

The styrene synthetic rubber is a synthetic rubber in which at least styrene, as a material monomer, is used.

The styrene synthetic rubber is not particularly limited and examples thereof include a styrene-butadiene rubber such as a styrene-butadiene random copolymer, a styrene-butadiene-styrene block copolymer, a styrene-ethylene-butadiene copolymer, and a styrene-ethylene-butadiene-styrene block copolymer and a styrene-isoprene rubber such as a styrene-isoprene-styrene block copolymer.

These styrene rubbers can be used alone or in combination.

Of the styrene rubbers, preferably, a styrene-butadiene rubber is used.

In the styrene-butadiene rubber, the content of the styrene is, for example, 17 to 65 mass %, or preferably 18 to 46 mass % and the Mooney viscosity (ML 1+4, at 100° C.) is, for example, 20 to 80, or preferably 25 to 50.

The mixing ratio of the rubber with respect to 100 parts by mass of the curable composition is, for example, 5 to 60 parts by mass, or preferably 10 to 30 parts by mass.

In the mixture of the epoxy resin and the rubber, the mixing ratio of the epoxy resin with respect to 100 parts by mass of the mixture is, for example, 30 to 95 parts by mass, or preferably 40 to 90 parts by mass.

When the thermosetting resin contains the epoxy resin, preferably, the curable composition contains a curing agent.

The curing agent is an epoxy resin curing agent and is a compound which has an activity within a temperature range of 80 to 200° C. The curing agent is not particularly limited and examples thereof include an amine compound, an acid anhydride compound, an amide compound, a hydrazide compound, an imidazole compound, and an imidazoline compound.

The amine compound is not particularly limited and examples thereof include ethylene diamine, propylene diamine, diethylene triamine, triethylene tetramine, and amine adducts thereof; methaphenylene diamine, diaminodiphenyl methane; and diaminodiphenyl sulfone.

The acid anhydride compound is not particularly limited and examples thereof include phthalic anhydride, maleic anhydride, tetrahydrophthalic anhydride, hexahydrophthalic anhydride, methyl nadic anhydride, pyromelletic anhydride, dodecenylsuccinic anhydride, dichloro succinic anhydride, benzophenone tetracarboxylic anhydride, and chlorendic anhydride.

The amide compound is not particularly limited and examples thereof include dicyandiamide and polyamide.

The hydrazide compound is not particularly limited and an example thereof includes dihydrazide such as adipic acid dihydrazide.

The imidazole compound is not particularly limited and examples thereof include methyl imidazole, 2-ethyl-4-methyl imidazole, ethyl imidazole, isopropyl imidazole, 2,4-dimethyl imidazole, phenyl imidazole, undecyl imidazole, heptadecyl imidazole, 2-phenyl-4-methyl imidazole.

The imidazoline compound is not particularly limited and examples thereof include methyl imidazoline, 2-ethyl-4-methyl imidazoline, ethyl imidazoline, isopropyl imidazoline, 2,4-dimethyl imidazoline, phenyl imidazoline, undecyl imidazoline, heptadecyl imidazoline, 2-phenyl-4-methyl imidazoline.

These curing agents can be used alone or in combination. A curing agent modified from the curing agent can be also used.

Of the curing agents, in view of storage stability, preferably, a latent curing agent is used.

The latent curing agent is a curing agent which is solid at normal temperature and is brought into a liquid state at a predetermined temperature to cure a resin. Examples thereof include an amine compound, an amide compound, and a dihydrazide compound.

Of the latent curing agents, preferably, dicyandiamide or the like is used.

The mixing ratio of the curing agent with respect to 100 parts by mass of the epoxy resin is, for example, 3 to 30 parts by mass, or preferably 5 to 25 parts by mass.

The curable composition contains a curing accelerator with the curing agent as required.

The curing accelerator is not particularly limited and examples thereof include a urea compound (including 3-(3,4-dichlorophenyl)-1,1-dimethylurea (DCMU)), an imidazole compound, tertiary amines, phosphorus compounds, quaternary ammonium salts, and organic metal salts.

These curing accelerators can be used alone or in combination.

Of the curing accelerators, preferably, 3-(3,4-dichlorophenyl)-1,1-dimethylurea (DCMU) or the like is used.

The mixing ratio of the curing accelerator with respect to 100 parts by mass of the epoxy resin is, for example, 0.1 to 20 parts by mass, or preferably 1 to 15 parts by mass.

When the thermosetting resin contains a rubber, preferably, the curable composition contains a cross-linking agent (a vulcanizing agent).

The cross-linking agent is a rubber cross-linking agent and is not particularly limited. Examples thereof include sulfur, peroxide, quinone dioxime, metal oxide (for example, zinc oxide, magnesium oxide, and the like), and alkylphenol.

These cross-linking agents can be used alone or in combination.

Of the cross-linking agents, in view of storage stability and reinforcing characteristics, preferably, sulfur is used.

The mixing ratio of the cross-linking agent with respect to 100 parts by mass of the rubber is, for example, 1 to 50 parts by mass, or preferably 10 to 40 parts by mass.

The curable composition contains a cross-linking accelerator, a cross-linking auxiliary agent, and the like with the cross-linking agent as required.

The cross-linking accelerator (a vulcanization accelerator) is not particularly limited and examples thereof include an aldehyde ammonia compound, an aldehyde amine compound, a thiourea compound, a thiazole compound, a sulfenamide compound, a thiuram compound, and a dithiocarbamate compound.

These cross-linking accelerators can be used alone or in combination.

Of the cross-linking accelerators, preferably, a thiazole compound is used.

The mixing ratio of the cross-linking accelerator with respect to 100 parts by mass of the rubber is, for example, 1 to 40 parts by mass, or preferably 10 to 30 parts by mass.

The cross-linking auxiliary agent (a vulacanization auxiliary agent) is not particularly limited and examples thereof include zinc oxide and magnesium oxide.

These cross-linking auxiliary agents can be used alone or in combination.

Of the cross-linking auxiliary agents, preferably, zinc oxide is used.

The mixing ratio of the cross-linking auxiliary agent with respect to 100 parts by mass of the rubber component is, for example, 1 to 30 parts by mass, or preferably 3 to 20 parts by mass.

The curable composition contains a metal which has a higher ionization tendency than that of the metal adherend in addition to the above-described thermosetting resin.

Examples of the metal which has a higher ionization tendency than that of the metal adherend include zinc, aluminum, magnesium, or calcium when the metal adherend is, for example, a cold rolled steel plate, a hot rolled steel plate, a zinc-plated steel plate, an aluminum zinc-plated steel plate, an aluminum-plated steel plate, a stainless steel plate, or the like.

Examples of the metal which has a higher ionization tendency than that of the metal adherend include iron, zinc, aluminum, magnesium, or calcium when the metal adherend is, for example, a nickel zinc-plated steel plate or the like and examples thereof include nickel, iron, zinc, aluminum, magnesium, or calcium when the metal adherend is, for example, a tin plate or the like.

Examples of the metal which has a higher ionization tendency than that of the metal adherend include tin, nickel, iron, zinc, aluminum, magnesium, or calcium when the metal adherend is, for example, a lead tin-plated steel plate (a terne-plated steel plate) or the like and examples thereof include lead, tin, nickel, iron, zinc, aluminum, magnesium, or calcium when the metal adherend is, for example, a copper-plated steel plate or the like.

These metals can be used alone or in combination.

Of the metals, in view of stability and safety, preferably, zinc is used.

The average particle size of the metal is, for example, 10 μm to 200 μm, or preferably 60 μm to 150 μm.

The mixing ratio of the metal with respect to 100 parts by mass of the thermosetting resin is, for example, 5 to 100 parts by mass, or preferably 10 to 80 parts by mass.

The curable composition contains the electrically-conductive carbon. By allowing the electrically-conductive carbon to be contained, even when the metal adherend does not come into contact with the metal which has a higher ionization tendency than that of the metal adherend, the metal adherend can be electrically conducted to the metal via the electrically-conductive carbon. Therefore, the used amount of the metal which has a higher ionization tendency than that of the metal adherend can be reduced, so that the weight reduction of the reinforcing sheet can be achieved.

The electrically-conductive carbon is not particularly limited and examples thereof include acetylene black, ketjen black, furnace black, channel black, thermal black, and carbon nanotube.

These electrically-conductive carbons can be used alone or in combination.

Of the electrically-conductive carbons, in view of electrically-conductive characteristics, preferably, acetylene black is used.

The mixing ratio of the electrically-conductive carbon with respect to 100 parts by mass of the thermosetting resin is, for example, 5 to 100 parts by mass, or preferably 10 to 80 parts by mass.

Furthermore, in addition to the above-described component, a filler and a tackifier, and moreover, if necessary, a known additive such as a softener, a foaming agent, an anti-sagging agent (a thixotropic-imparting agent), a low-polarity rubber, a pigment, a thixotropic agent, a lubricant, an antiscorching agent, a stabilizer, or an oxidation inhibitor can be added to the curable composition at an appropriate proportion.

The filler is not particularly limited and examples thereof include calcium carbonate (for example, heavy calcium carbonate, light calcium carbonate, Hakuenka, and the like), talc, mica, clay, mica powder, silica, alumina, aluminum silicate, titanium oxide, and glass powder.

These fillers can be used alone or in combination.

Of the fillers, preferably, calcium carbonate is used.

The mixing ratio of the filler with respect to 100 parts by mass of the thermosetting resin is, for example, 1 to 500 parts by mass, or preferably 10 to 300 parts by mass.

The tackifier is not particularly limited and examples thereof include a rosin resin, a terpene resin (for example, a terpene-aromatic liquid resin and the like), a coumarone-indene resin, and a petroleum resin (for example, a C5/C9 petroleum resin and the like).

These tackifiers can be used alone or in combination.

Of the tackifiers, preferably, a petroleum resin such as a C5/C9 petroleum resin is used.

The mixing ratio of the tackifier with respect to 100 parts by mass of the thermosetting resin is, for example, 5 to 150 parts by mass, or preferably 10 to 40 parts by mass.

The above-described components are blended at the above-described mixing proportion and are kneaded with, though not particularly limited, for example, a mixing roll, a pressure kneader, an extruder, or the like, so that the curable composition is prepared as a kneaded product.

Thereafter, the obtained kneaded product is extended by applying pressure by, for example, a calendering, an extrusion molding, a press molding, or the like, so that the resin layer is laminated on the surface of a releasing paper or the like. In this way, the resin layer can be formed.

The thickness of the resin layer is, for example, 0.5 to 3 mm, or preferably 0.5 to 1.3 mm

Preferably, the volume resistivity of the resin layer is low. The volume resistivity of the resin layer is, for example, 1×10⁸ Ω cm or less, preferably 5×10⁷ Ω cm or less, or more preferably 1×10⁷ Ω cm or less. The volume resistivity can be measured in conformity with a method described in ASTM D991.

Next, the constraining layer is bonded to the surface that is the opposite side with respect to the laminated side of the releasing paper in the resin layer, so that the reinforcing sheet is obtained.

The constraining layer is provided so as to impart toughness to the resin layer after curing (hereinafter, defined as a cured product layer). The constraining layer is in a sheet shape, light in weight, and a thin film. Preferably, the constraining layer is formed from a material that allows close contact and integration with the cured product layer. The material is not particularly limited and examples thereof include a glass cloth, a resin impregnated glass cloth, a synthetic resin non-woven fabric, a carbon fiber, and a polyester film.

The glass cloth is cloth formed from a glass fiber and a known glass cloth is used.

The resin impregnated glass cloth is obtained by performing an impregnation treatment of a synthetic resin such as a thermosetting resin and a thermoplastic resin into the above-described glass cloth and a known resin impregnated glass cloth is used. The thermosetting resin is not particularly limited and examples thereof include an epoxy resin, a urethane resin, a melamine resin, and a phenol resin. Also, the thermoplastic resin is not particularly limited and examples thereof include a vinyl acetate resin, an ethylene-vinyl acetate copolymer (EVA), a vinyl chloride resin, and an EVA-vinyl chloride resin copolymer.

The above-described thermosetting resins and thermoplastic resins can be used alone or in combination, respectively.

The synthetic resin non-woven fabric is not particularly limited and examples thereof include a polypropylene resin non-woven fabric, a polyethylene resin non-woven fabric, and an ester-based resin non-woven fabric.

The carbon fiber is cloth made of a fiber mainly composed of carbon and a known carbon fiber is used.

The polyester film is not particularly limited and examples thereof include a polyethylene terephthalate (PET) film, a polyethylene naphthalate (PEN) film, and a polybutylene terephthalate (PBT) film. Preferably, a PET film is used.

Of the constraining layers, in view of adhesiveness, strength, and cost, preferably, a glass cloth and a resin impregnated glass cloth are used.

The thickness of the constraining layer is, for example, 0.05 to 2.0 mm, or preferably 0.1 to 1.0 mm

The total thickness of the resin layer and the constraining layer is substantially set to be in the range of, for example, 0.55 to 5.0 mm

The resin layer and the constraining layer can be bonded to each other by, for example, compression bonding, thermal compression bonding, or the like.

The reinforcing sheet obtained in this manner is bonded to the metal adherend to reinforce the metal adherend. An example of the metal adherend includes a steel plate used in various industrial machines including transportation machines.

The steel plate is not particularly limited and examples thereof include a cold rolled steel plate, a hot rolled steel plate, a zinc-plated steel plate, a tin plate, a lead tin-plated steel plate (a terne-plated steel plate), a copper-plated steel plate, an aluminum-plated steel plate, a nickel zinc-plated steel plate, an aluminum zinc-plated steel plate, and a stainless steel plate.

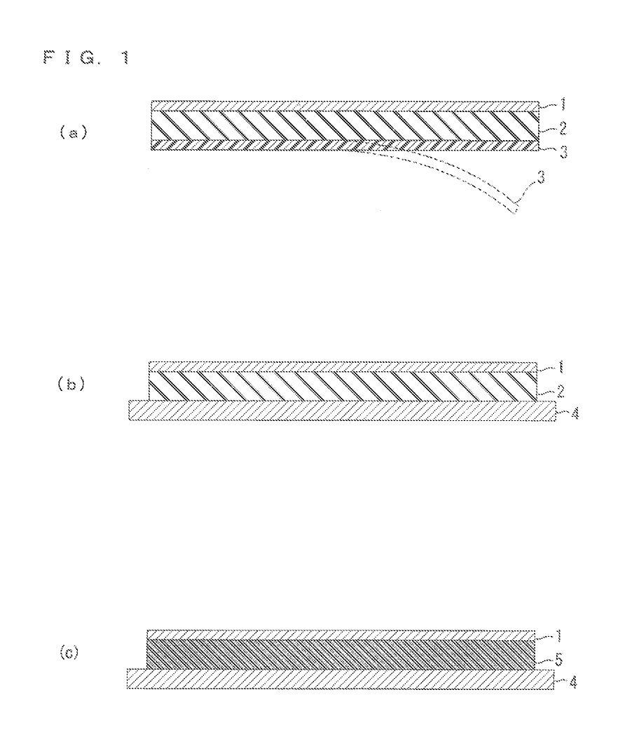

To be more specific, in the reinforcing sheet, as shown in FIG. 1 (a), a resin layer 2 is laminated on a constraining layer 1 and a releasing paper 3 is bonded to the surface of the resin layer 2 as required. At the time of its use, as shown by a phantom line, the releasing paper 3 is peeled from the surface of the resin layer 2 and as shown in FIG. 1 (b), the surface of the resin layer 2 is bonded to a steel plate 4 as the metal adherend to be thereafter, as shown in FIG. 1 (c), cross-linked and cured by heating at a predetermined temperature (for example, 160 to 210° C.), so that a cured product layer 5 is formed and therefore, the reinforcing sheet reinforces the steel plate 4 as the metal adherend.

When the reinforcing sheet of the present invention is bonded to the automobile steel plate or the like, the steel plate is subjected to an electrodeposition coating after the reinforcing sheet is bonded thereto. The resin layer is cross-linked and cured using heat at the time of drying the coating. In this manner, the steel plate is reinforced.

In this method, a portion of the steel plate to which the reinforcing sheet is bonded is not subjected to a coating. However, even when water or oxygen infiltrates a bonded portion of the reinforcing sheet in the steel plate, in the bonded portion, the metal adherend is not easily oxidized while the metal contained in the resin layer is oxidized for sacrificial protection due to the function of a local cell. That is, the metal which has a higher ionization tendency than that of the steel plate contained in the resin layer is sacrificially oxidized before the oxidation of the steel plate and emits electrons. On the other hand, the emitted electrons are supplied to the steel plate, so that it is possible to prevent emission of electrons from the steel plate and to reduce the oxidation of the steel plate.

Accordingly, the steel plate as the metal adherend can be reinforced and the oxidation of the steel plate is sufficiently reduced, so that the occurrence of corrosion such as rust can be reduced.

### EXAMPLES

The present invention will now be described in more detail by way of Examples and Comparative Example. However, the present invention is not limited to the following Examples and Comparative Example.

### Examples and Comparative Example

Kneaded products were prepared in accordance with the mixing formulation shown in Table 1 by blending the components and kneading the mixture with a 10-inch mixing roll. In the kneading, first, an epoxy resin, a rubber, zinc powders, an electrically-conductive carbon, a filler, and a tackifier were kneaded with a mixing roll heated at 120° C. Thereafter, the kneaded product was cooled to 50 to 80° C. and furthermore, a latent curing agent, a curing accelerator, a cross-linking agent, a cross-linking accelerator, and a cross-linking auxiliary agent were added to the kneaded product to be kneaded with a mixing roll, so that a kneaded product (a curable composition) was obtained.

Next, each of the obtained kneaded products was extended by applying pressure into a sheet shape by a press molding to be laminated on the surface of a releasing paper, so that a resin layer having a thickness of 1.0 mm was formed.

Thereafter, a constraining layer made of a glass cloth having a thickness of 0 2 mm was bonded to the surface that is the opposite side with respect to the laminated side of the releasing paper in the resin layer by heat pressing and the total thickness of the resin layer and the constraining layer was adjusted to be 1.2 mm, so that a reinforcing sheet was fabricated.

### Evaluation

The volume resistivity, the reinforcing characteristics, and a rust test of the obtained reinforcing sheets in Examples and Comparative Example were measured/conducted as follows.

(1) Volume Resistivity

In Examples and Comparative Example, the volume resistivity of the resin layers in the reinforcing sheets was measured by a measuring method in conformity with ASTM D991. The results are shown in Table 1.

(2) Reinforcing Characteristics

Each of the reinforcing sheets in Examples and Comparative Example was cut out into a width of 25 mm×a length of 150 mm The releasing paper of the cut-out reinforcing sheet was peeled off and the reinforcing sheet was bonded to a cold rolled steel plate (SPCC-SD, manufactured by Nippon Testpanel Co., Ltd.) having a width of 25 mm×a length of 150 mm×a thickness of 0.8 mm under a 20° C. atmosphere to be heated at 180° C. for 20 minutes, so that the resin layer was cured and a test piece was obtained.

Thereafter, in a state where the steel plate faced upwardly, the test piece was supported with a span of 100 mm and a testing bar was lowered from above in the vertical direction to the center in the longitudinal direction thereof at a compression rate of 1 mm/min The bending strength (N/25 mm) at the time when the cured product layer was displaced by 1 mm and that at the time when the cured product layer was displaced by 2 mm after allowing the testing bar to come into contact with the steel plate were measured, respectively. The obtained values were evaluated as reinforcing characteristics. The results are shown in Table 1.

(3) Rust Test

0.05 mL of 5 mass % salt water was added dropwise to a cold rolled steel plate (SPCC-SD, manufactured by Nippon Testpanel Co., Ltd.) having a width of 100 mm×a length of 100 mm×a thickness of 0.8 mm. Then, each of the reinforcing sheets cut out into a width of 50 mm×a length of 50 mm in Examples and Comparative Example was bonded onto the steel plate to be then allowed to stand for 5 hours. Thereafter, the resulting product was heated at 180° C. for 20 minutes, so that the resin layer was cured and a test piece was obtained.

The reinforcing sheets of Examples and Comparative Example were peeled from each of the test pieces one day after the curing of the resin layer and the state of the steel plate was observed. The results are shown in Table 1.

TABLE 1

| | | | Ex. · Comp. Ex. | | | |
|---|---|---|---|---|---|---|
| | | | Ex. 1 | Ex. 2 | Ex. 3 | Comp. Ex. |
| Mixing Formulation of | Epoxy Resin | | 60 | 60 | 60 | 60 |
| Curable Composition | Rubber | NBR | 40 | 40 | 40 | 40 |
| (Resin Layer) | | SBR | 5 | 5 | 5 | 5 |
| | Metal (Zinc) | Average Particle | 25 | 50 | — | — |
| | | Size 50 μm | | | | |
| | | 100 μm | — | — | 50 | — |
| | Electrically-Conductive Carbon | Acetylene Black | 50 | 50 | 50 | 50 |
| | Filler | CaCo₃ | 25 | 25 | 25 | 25 |
| | Tackifier | C5/C9 Resin | 20 | 20 | 20 | 20 |
| | Latent Curing Agent | Dicyandiamide | 5 | 5 | 5 | 5 |
| | Curing Accelerator | DCMU | 2 | 2 | 2 | 2 |
| | Cross-Linking Agent | Sulfur | 15 | 15 | 15 | 15 |
| | Cross-Linking Accelerator | DM | 10 | 10 | 10 | 10 |
| | Cross-Linking Auxillary Agent | Zinc Oxide | 5 | 5 | 5 | 5 |
| Evaluation | Volume Resistivity (Ωcm) | | 3.2 × 10⁴ | 2.9 × 10⁴ | 2.8 × 10⁴ | 3.3 × 10⁴ |
| | Reinforcing Characteristics | Strength at Time | 20 | 21 | 21 | 20 |
| | | of Displacement | | | | |
| | | of 1 mm | | | | |
| | (N/25 mm) | Strength at Time | 35 | 37 | 37 | 34 |
| | | of Displacement | | | | |
| | | of 2 mm | | | | |
| | Rust Test | State in Bonded | Slightly Grayish | Slightly Grayish | Slightly Grayish | Entirely Black, |
| | | Portion | White | White | White | Dark Brown |

Abbreviations of the components in Table 1 are shown in the following.

Epoxy resin: a bisphenol A epoxy resin (#834, an epoxy equivalent of 230 to 270 g/eq., a semi-solid state (at normal temperature), manufactured by Japan Epoxy Resins Co., Ltd.)

NBR: an acrylonitrile-butadiene rubber (Nipol 1052J, a content of acrylonitrile of 33. 5 mass %, Mooney viscosity of 77.5 (ML 1+4, at 100° C.), a solid state (at normal temperature), manufactured by ZEON CORPORATION)

SBR: a styrene-butadiene rubber (Asaprene 2003, a content of styrene of 25%, Mooney viscosity of 33 (ML 1+4, at 100° C.), manufactured by Asahi Kasei Chemicals Corporation)

Acetylene black: (DENKA BLACK particle-shaped product, manufactured by DENKI KAGAKU KOGYO KABUSHIKI KAISHA)

CaCO₃: calcium carbonate (manufactured by MARUO CALCIUM CO., LTD.)

C5/C9 resin: C5/C9 petroleum resin (U185, manufactured by ZEON CORPORATION

DCMU: a urea compound, 3-(3,4-dichlorophenyl)-1,1-dimethylurea (DCMU, manufactured by HODOGAYA CHEMICAL CO., LTD.)

DM: di-2-benzothiazolyl disulfide (a thiazole vulcanization accelerator, NOCCELER-DM, manufactured by OUCHI SHINKO CHEMICAL INDUSTRIAL CO., LTD.)

While the illustrative embodiments of the present invention are provided in the above description, such is for illustrative purpose only and it is not to be construed as limiting the scope of the present invention. Modification and variation of the present invention that will be obvious to those skilled in the art is to be covered by the following claims.

### INDUSTRIAL APPLICABILITY

The reinforcing sheet of the present invention can be used in a reinforcing method in which a steel plate or the like is reinforced by bonding the reinforcing sheet to the steel plate or the like of various industrial products.

1. A reinforcing sheet to be bonded to a metal adherend comprising:
a resin layer and
a constraining layer laminated on the resin layer, wherein
the resin layer contains a thermosetting resin, a metal which has a higher ionization tendency than that of the metal adherend, and an electrically-conductive carbon.

2. The reinforcing sheet according to claim 1, wherein
the volume resistivity of the resin layer is 1×10⁸ Ω cm or less.

3. The reinforcing sheet according to claim 1, wherein
the metal is zinc.

4. The reinforcing sheet according to claim 1, wherein
the resin layer further contains a curing agent and the thermosetting resin further contains an epoxy resin.

5. The reinforcing sheet according to claim 1, wherein
the resin layer further contains a cross-linking agent and the thermosetting resin further contains a rubber.

6. The reinforcing sheet according to claim 1, wherein
the constraining layer is made of a glass cloth.

7. A reinforcing method comprising:
bonding a reinforcing sheet to a metal adherend to heat a resin layer, wherein
the reinforcing sheet comprises:
the resin layer and
a constraining layer laminated on the resin layer, and
the resin layer contains a thermosetting resin, a metal which has a higher ionization tendency than that of the metal adherend, and an electrically-conductive carbon.

8. A reinforcing method comprising:
bonding a reinforcing sheet to a steel plate or a zinc-plated steel plate to heat a resin layer, wherein
the reinforcing sheet comprises:
the resin layer and
a constraining layer laminated on the resin layer, and
the resin layer contains a thermosetting resin, zinc, and an electrically-conductive carbon.
